(19) United States
(12) Patent Application Publication
(10) Pub. No.: US 2026/0161971 A1
(43) Pub. Date: Jun. 11, 2026

(54) LOW-LEVEL FOUR-DIMENSIONAL VISION PERCEPTION

(71) Applicant: NVIDIA Corp., Santa Clara, CA (US)

(72) Inventors: Abhishek Badki, Santa Clara, CA (US); Hang Su, Cambridge, MA (US); Orazio Gallo, Santa Cruz, CA (US); Bowen Wen, Issaquah, WA (US)

(73) Assignee: NVIDIA Corp., Santa Clara, CA (US)

(21) Appl. No.: 19/309,196

(22) Filed: Aug. 25, 2025

Related U.S. Application Data
(60) Provisional application No. 63/729,239, filed on Dec. 6, 2024.

(51) Int. Cl. G06N 5/04

(52) U.S. Cl. CPC G06N 5/04

(57) ABSTRACT

Feedforward reasoning models that include a video encoder configured to generate feature tokens from an input video, at least one dense attention head, at least one sparse attention head with two-way attention logic configured to transform settings from the feature tokens into a tracking token, a depth token, and a visibility token in accordance with an input prompt, and logic configured to transform the tracking token, depth token, and visibility token into track predictions for an object specified by the input prompt.

### CROSS-REFERENCE TO RELATED APPLICATIONS

This application claims priority and benefit under 35 U.S.C. 119 (e) to U.S. Application Ser. No. 63/729,239, “A Unified Framework for Low-Level 4D Vision Perception”, filed on Dec. 6, 2024, the contents of which are incorporated herein by reference in their entirety.

### BACKGROUND

The spatio-temporal (positional and time-sequence) relationship between the pixels of a video carry important information for low-level motion perception. Conventional machine learning models that are trained to solve several such different motion perception tasks accurately utilize multiple network architectures each specialized for a particular task, increasing their computational complexity, energy consumption, and/or memory utilization.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts a machine model video perception system in accordance with one embodiment.

FIG. 2 depicts a sparse attention head of a machine model video perception system in accordance with one embodiment.

FIG. 3 depicts a parallel processing unit in accordance with one embodiment.

FIG. 4 depicts a general processing cluster in accordance with one embodiment.

FIG. 5 depicts a memory partition unit in accordance with one embodiment.

FIG. 6 depicts a streaming multiprocessor in accordance with one embodiment.

FIG. 7 depicts a processing system in accordance with one embodiment.

FIG. 8 depicts an exemplary processing system in accordance with another embodiment.

### DETAILED DESCRIPTION

Disclosed herein are feedforward reasoning models for solving multiple different low-level video perception tasks utilizing a common structure. The disclosed mechanisms comprise a pretrained video encoder and per-task heads that may each comprise parameters configured with light training. The disclosed mechanisms may be utilized for example on deep motion perception tasks such as depth and optical flow estimation and one sparse motion perception tasks such as two- or three-dimensional (2D and 3D) tracking.

Generally, the disclosed mechanisms comprise a deep learning model frameworks that learns to estimate the motion-based priors of large video data sets. The frameworks enables sharing of estimated motion priors among deep and sparse tasks. Dense tasks are those for which reasoning models make a prediction for each pixel in a frame or image. Sparse tasks are those for which the reasoning models make prediction(s) based on an input query, wherein the query involves a subset of less than all (typically much less) of the pixels in a frame or image. The framework comprises a relatively heavily-trained video encoder that generates video feature tokens that are processed with “lightweight” attention heads that comprise relatively fewer parameters requiring less extensive training than the video encoder. The framework may be configured to estimate general, task-independent motion priors that are applied to and transformed by the attention heads into task-dependent tokens carrying motion perception information about particular videos in accordance with an input prompt.

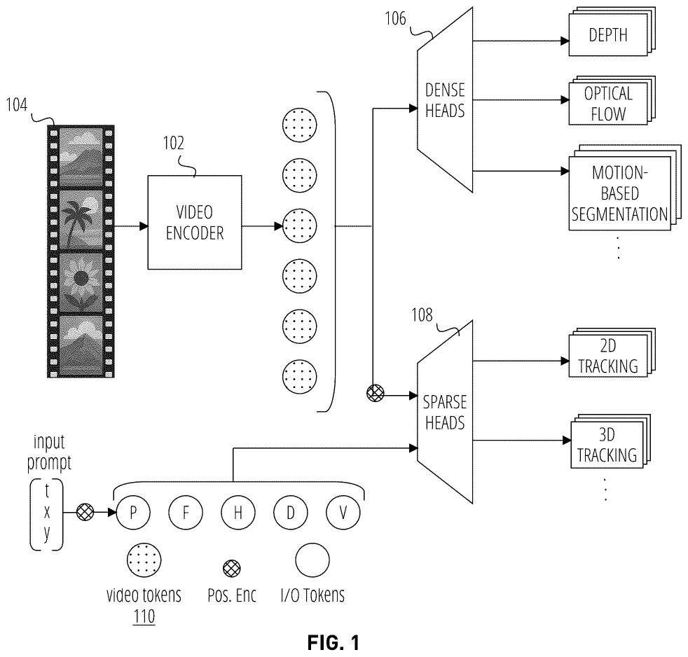

Referring to FIG. 1, the disclosed frameworks comprise a pretrained video encoder 102 configured to capture spatio-temporal features of a video 104 of length T timesteps, e.g., frames. Task-specific dense attention heads 106 and sparse attention heads 108 decode the video features for different 3D (2D over time) and 4D (3D over time, i.e., “spatio-temporal”) video perception tasks.

Different dense attention heads 106 may be utilized for different dense tasks. The dense heads may comprise similar structural elements with structural differences (e.g., final layers) among them reflecting the different specific tasks they perform. Likewise, different sparse attention heads 108 may be applied to different sparse tasks, with the different sparse attention heads 108 comprising some structural similarities and some differences (e.g., in the final layer).

Non-limiting examples of dense perception tasks that may be implemented by this framework include: (1) the generation of per-frame depth maps that for each pixel in the video frames provide an estimate of how distant each pixel is from a reference plane, e.g., a camera position; (2) optical flow analysis estimating, for each pixel of each frame, where that pixel was in one or more prior frames; and (3) motion based segmentation tracking whether an object in the video corresponding to a particular pixel is dynamic (moving) with respect to static scene elements.

Non-limiting examples of sparse perception tasks that may be implemented in the disclosed frameworks include: (1) two-dimensional (2D) position tracking of a pixel or pixels across frames of the video, and (2) three-dimensional (3D) position tracking of a pixel or pixels across frames of the video. The 3D tracking may be enabled by combining depth maps generated by dense perception with 2D tracks and pixel visibility (occlusion) estimates generated by sparse perception.

A dense prediction task in machine learning involves making predictions at every or most points of the input. Dense prediction is commonly applied in image and video processing tasks for which an output is estimated generated for every pixel, voxel, or location of the input. Examples of dense prediction tasks include semantic segmentation (assigning a class label to each pixel in an image), instance segmentation (differentiating between individual objects and labeling each pixel accordingly), depth estimation (predicting the depth value for each pixel in an image), and optical flow (estimating the motion of pixels between consecutive video frames).

Dense prediction tasks commonly utilize neural network architectures capable of processing spatial information, such as fully convolutional networks (FCNs) or variants that incorporate encoder-decoder structures such as well-known U-Net or DeepLab network structures.

A dense prediction head may be utilized for pixel-wise dense tasks such as depth and flow estimation and motion-based segmentation. A Dual Path Transformer (DPT) attention mechanism combines the strengths of Vision Transformers (ViTs) and Convolutional Neural Networks (CNNs) to process both local and global information effectively. The dense attention heads 106 of the disclosed frameworks may comprise a structure similar to that utilized in the DPT model for images, with modifications to adapt the dense heads to work with video features.

A DPT head may utilize two distinct processing paths, one path for global context modeling via transformer blocks, and a distinct path for local detail processing using convolutional operations. This dual-path approach enables the model to capture both fine details and holistic (global) features and context of inputs. In the global path, the transformer block encoder processes image or (in the disclosed frameworks) video patches, capturing long-range dependencies and global relationships effectively through multi-head self-attention layers.

The local path may be configured to extract spatially detailed information using convolutional layers to help ensure that high-resolution feature maps are maintained for spatial accuracy. The DPT head may utilize a cross-attention mechanism that integrates information between the global and local paths. This enables information extracted through global self-attention to refine local features and vice versa, enhancing both contextual and positional accuracy.

Outputs from both paths may be integrated in a task-specific fusion layer where features are combined to produce a final prediction, ensuring that both paths contribute optimally to a task-specific outcome.

A sparse task is one involving sparse data or features, where most of the data values are zero or missing. Sparse tasks are common in domains such as natural language processing, collaborative filtering, video processing, and computer vision. Pixel tracking in a video may be treated as a sparse task when it involves tracking a limited number of key points or pixels rather than processing every pixel in every frame. Sparse pixel tracking tasks tend to be computationally efficient compared to dense tasks that involve analyzing all pixels frame by frame.

For the sparse task of tracking a pixel in a video, sparse heads may be configured to decode video tokens into a 2D trajectory, to track the pixel's depth with respect to the camera, and the track visibility in each frame. To enable such tracking for arbitrarily long videos, the disclosed frameworks may utilize sliding, overlapping windows of T frames and may apply estimated 3D tracks and the corresponding decoded tokens in one window to estimate 3D tracks in the next.

A video encoder may be operated to generate tokens (tensors) from the input video comprising motion priors. For sparse tasks, such as 3D tracking, additional query tokens may be generated from an input prompt specifying the pixel or pixels to track, along with tokens herein labeled [symbol] , [symbol] , [symbol] , [symbol] , and [symbol] (each elaborated on below).

In one embodiment, the video encoder comprises a ViT-based video encoder from VideoMAEv2, pre-trained using a masked auto-encoding task.

The video encoder may receive batches of video frames of dimensions T×H×W, where T is a number of frames in the batch, and H and W are the height and width of the frames, in pixels. The video encoder may apply a spatio-temporal patch-size of T×H×W and cube embedding to transform an input video into a sequence of motion feature tokens. These tokens may be further processed with spatio-temporal attention to generate output tokens [symbol] ∈ [symbol] , where P is the number of tokens and C is the embedding dimension.

The video encoder may be operated once per video clip. Once the video clips are encoded into the feature tokens, lightweight heads may be applied to decode the tokens to desired dense and sparse outputs.

Dense prediction tasks produce outputs with spatial dimensions aligned with their inputs, typically at the same resolution H×W. Many types of common computer vision tasks may be formulated as dense prediction tasks. Examples as previously noted include depth estimation, optical flow estimation, and motion-based segmentation.

Some dense prediction tasks involve the capture of both fine and long-range spatial structures from the video. The disclosed mechanisms may utilize a DPT structure for the dense prediction heads due to the performance and efficiency of these structures. DPT progressively assembles and combines tokens from various layers inside transformer blocks to produce full-resolution predictions. To apply the tokens generated by the video encoder and to enable temporal reasoning, the 2D convolutions inside a conventional DPT head may be replaced with 3D convolutions in the disclosed frameworks. This modification may suffice to enable temporal consistency with acceptable computation overhead.

The macro structure (e.g., layering) of DPT heads for each of dense task may differ from one another only in the final layer. The final layer of each DPT head may output one channel for depth and motion-based segmentation and two channels for optical flow. For videos exceeding a frame batch processing size T, inference may be carried out with stride T/2. For depth estimation, the overlapping frames of a current window may be aligned with a window for the immediately prior batch using least-square fitting. This may may improve long-term temporal consistency when processing long videos. For optical flow and motion-based segmentation, predictions may be overwritten with overlapping ones.

The 3D trajectory of a pixel coordinate (tᵢ, xᵢ, yᵢ) in a time sequence of video frames may be estimated by

$${Frame}_{i} = {\{ {\hat{x}}_{i} ( t ) , {\hat{y}}_{i} ( t ) , {\hat{d}}_{i} ( t ) , {\hat{v}}_{i} ( t ) \}}_{t = 0}^{T - 1}$$

where at timestep t, (\hat{x}ᵢ(t),ŷᵢ(t)) denotes the 2D track location, \hat{d}ᵢ(t) is the track depth with respect to the camera plane, and \hat{v}ᵢ(t) is the track visibility, indicating if a track is visible or occluded.

Tracking a pixel through a video may present a challenging task. The pixel should be tracked in 2D when visible and also through occlusions of the pixel. Tracking whether a pixel is visible or occluded involves reasoning about the depth of the pixel's track relative to nearby pixels.

Video encoders tend to have limited temporal context and may limited to processing videos over a maximal temporal window (e.g., some number T of frames). However it is desirable to track pixels for arbitrarily long videos that may comprise S>T frames. These requirements for pixel tracking make adapting a general-purpose attention head to the task particularly challenging.

The disclosed mechanisms may utilize a sparse attention head that estimates a 3D track of input pixels within the temporal context (T frames) of a video encoder. For track estimation beyond T frames, a memory mechanism may be utilized by the sparse attention head along with a particular training process.

Rather than direct estimation of point-track positions, the disclosed mechanisms may model pixel tracks as dense probability heatmaps. This enables sharing of the pixel tracks with other tasks. Positional encoding may be applied to an input prompt (e.g., using a multi-layer perceptron) to generate a prompt token [symbol] with an embedding dimension C matching dimension of the video feature tokens.

The disclosed mechanisms may utilize additional tokens with learnable embeddings to estimate different components of a 3D pixel track. These output tokens may comprise a heatmap token (H) to estimate the 2D pixel position of the track across the video, a depth (D) token, and a visibility (V) token. Input and output tokens may interact with the video tokens, S, which may also be encoded using 3D positional encoding. A two-way attention mechanism may be applied to decode the video features.

These video features may be reshaped and up-sampled. A final inner product of the video features with the additional tokens yields feature maps/masks of size T×H×W (per frame batch). For the 2D track estimation, this map may be interpreted as a probability distribution that encodes the 2D track position, to which a 2D SoftArgmax or similar operation is applied to estimate the 2D track position (\hat{x}ᵢ(t),ŷᵢ(t)) at each video frame (timestep) t.

For depth and visibility estimation, a 2D average pooling layer may be utilized, followed by exponential and sigmoid activations respectively to estimate the track depth \hat{d}ᵢ(t) and the visibility \hat{v}ᵢ(t) at each frame t. This mechanisms also enables points to be queried anywhere in the video and tracked in parallel.

A two-way attention mechanisms may be utilized similar in some respects to those used in segmenting models such as the Segment Anything Model (SAM). The two-way attention mechanisms may comprise a pair of two-way attention network layers. The disclosed mechanisms may for example replace the 2D convolutions in the conventional mask-decoder of a segmenting model with 3D convolutions.

One mechanisms for tracking a pixel beyond a window of size T frames is to chain together tracks in overlapping windows. Given the track estimation in a first window, an estimated 2D track position may be selected that comprises a visibility score in the overlapping region. This estimated position may prompt the track estimation in the next window. This mechanism works when the tracked pixel is visible in the overlapping windows, but may be prone to drifting and losing tracks between some overlapping windows, especially if the pixel or other object to track becomes occluded at some point in the video.

The disclosed mechanisms may utilize memory mechanisms that retain and pass useful information about a pixel track from one window to another. The video tokens decoded by the two-way attention stage may carry information about the track estimation in the current window to the next window.

One approach is to project the video tokens in the overlapping region via a linear layer and add them to the corresponding video tokens from the next processed window. This approach however is constrained to pass settings from only the overlapping regions, which may become problematic if the tracked point becomes occluded in one or more processing windows. The disclosed mechanisms may therefore utilize a token [symbol] that carries important tracking features from the current window to a next processing window.

The disclosed mechanisms may utilize a two-stage training mechanism, where in the first stage training of the video encoder network parameters is carried out for a single window of frames. In a second stage, parameters are frozen for all but a final few layers of the video encoder. The final layers may be fine-tuned along with the tracking heads for unrolled window training.

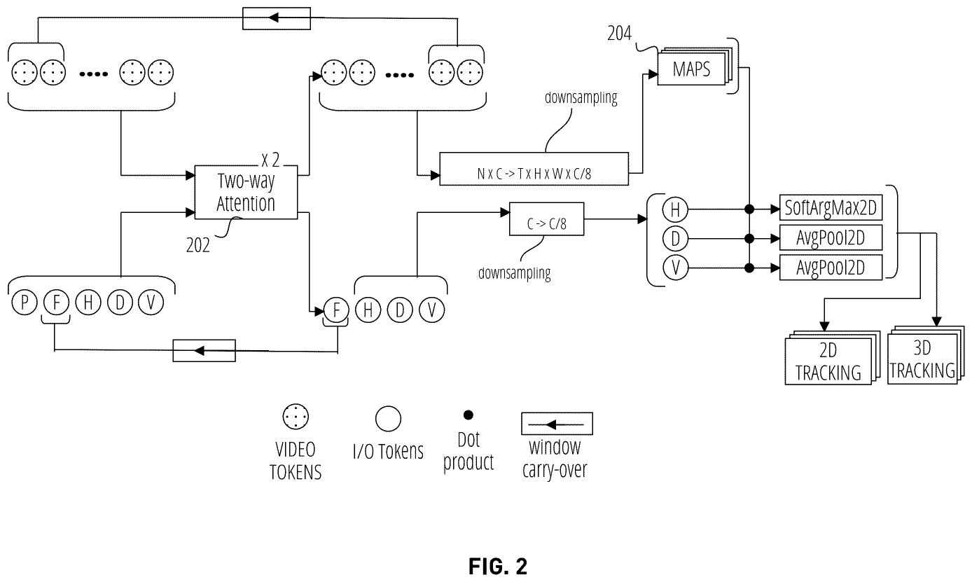

FIG. 2 depicts sparse head structure and logic in one embodiment.

In the depicted exemplary use case, inputs are a video and a prompt specifying a single pixel to track across the video frames (a sparse task). This use case may be readily extended to tracking multiple pixels, e.g., bounding boxes. The input pixel to track may be specified by it's coordinate x,y in an initial frame t to begin tracking from.

To track the bounding box (or bounding polygon) of an object that moves across frames of the input video, the prompt may specify a starting frame and the vertex points (pixels) of the polygon to track. Alternatively, a dense prediction may be generated to estimate motion segmentation of an object to track and a prompt may be applied indicating to track all or some of the points inside of the object segments. This approach may be extended to tracking of cuboids (3D bounding boxes) enabling the measurement of rotational movement of 3D objects depicted in the video frames.

The video encoder 102 parses the input video 104 into patches each comprising content from multiple frames. The patches have a temporal dimension and hence may be “cube patches” comprising pieces of each 2D frame with an extent spanning a time sequence. The video encoder 102 transforms each cube patch into a video token comprising a C-dimensional tensor. These tokens are further processed internally by the video encoder 102 via a well-known token mixing process (e.g., in the mixing performed by a ViT component of the video encoder 102), resulting in the output video tokens 110 utilized by the dense attention heads 106 and sparse attention heads 108. The content of the output video tokens 110 is representative of features of motion prior and other features of the video overall.

The input prompt for sparse tasks is encoded into a token P and a small set of additional tokens are initialized. All of these tokens may be combined via two-way attention layers 202 with the output video tokens 110 inside the sparse heads. In the depicted embodiment, five tokens are utilized comprising the settings needed to carry out the sparse tasks for which the sparse attention heads 108 are configured. The input prompt may be tokenized into P in known manners, e.g., through a multi-layer perceptron.

A number N of output video tokens 110 are derived from the video 104 and combined with the additional tokens (prompt/query token [symbol] , feature token [symbol] , heat map token [symbol] , depth token [symbol] , and visibility token [symbol] ) using, for example, a SAM-style two-way attention layer 202. The results are then downsampled (e.g., using transpose convolution) into per-frame feature maps. The heat map token [symbol] , depth map token [symbol] , and visibility map token [symbol] are dot-product combined with the feature maps/masks 204. The sparse attention head combines the output video tokens 110 with a token [symbol] that encodes video features, heat map, depth, and visibility information from a prior frame batch of the video.

The token [symbol] is configured to hold settings related to 2D tracking (probable object locations in the frames) during inference. The [symbol] token is configured to hold settings about depth of the pixel or other object to track. The [symbol] token is configured to hold settings about the visibility of the pixel or object to track. The [symbol] token is configured to carry tracking settings from these other tokens from the current processing window (of frames) to a next processing window. The [symbol] token is useful for carrying persistent tracking state settings across processing windows, e.g., where an object being tracked was last visible.

The [symbol] , [symbol] , and [symbol] tokens are configured during inference from a learned embedding. At inference time, they have initial values derived from the learned embedding but don't carry any information initially about the video features or the prompted output to generate. The two-way attention layers 202 cause an exchange of settings (video motion priors) between the output video tokens 110 and the [symbol] , [symbol] , and [symbol] tokens. Video priors relevant to 2D object tracking are mixed into the [symbol] token, priors relevant to determining whether a particular track is visible or not into the [symbol] token, and so on.

The dot (inner) products result in probability maps across the video frames. One such 2D probability map may comprise a probability distribution of where the object being tracked, e.g., one or more pixels, might be located in each frame. A SoftArgMax or similar layer operation may be performed on the probability distribution to obtain the most probable position of the tracked item in each frame as the maximum in that probability distribution.

The exemplary output layers generate position, depth, and visibility estimates that may be combined to provide 2D and 3D tracking of an object through frames of the input video 104.

The mechanisms disclosed herein may be implemented in and/or by computing devices utilizing one or more graphic processing unit (GPU) and/or general purpose data processor (e.g., a “central processing unit” or CPU). A graphics processing unit may be a standalone chip or package, or may comprise graphics processing circuitry integrated with a central processing unit. Exemplary architectures will now be described that may be configured to implement the mechanisms disclosed herein, for example via configuration of a memory 320 or main memory 804 with machine-readable instructions that when applied to one or more parallel processing unit 302, data processing cluster 412, and/or central processing unit 702 of a computer system.

The following description may use certain acronyms and abbreviations as follows:
“DPC” refers to a “data processing cluster”;
“GPC” refers to a “general processing cluster”;
“I/O” refers to a “input/output”;
“L1 cache” refers to “level one cache”;
“L2 cache” refers to “level two cache”;
“LSU” refers to a “load/store unit”;
“MMU” refers to a “memory management unit”;
“MPC” refers to an “M-pipe controller”;
“PPU” refers to a “parallel processing unit”;
“PROP” refers to a “pre-raster operations unit”;
“ROP” refers to a “raster operations”;
“SFU” refers to a “special function unit”;
“SM” refers to a “streaming multiprocessor”;
“Viewport SCC” refers to “viewport scale, cull, and clip”;
“WDX” refers to a “work distribution crossbar”; and
“XBar” refers to a “crossbar”.

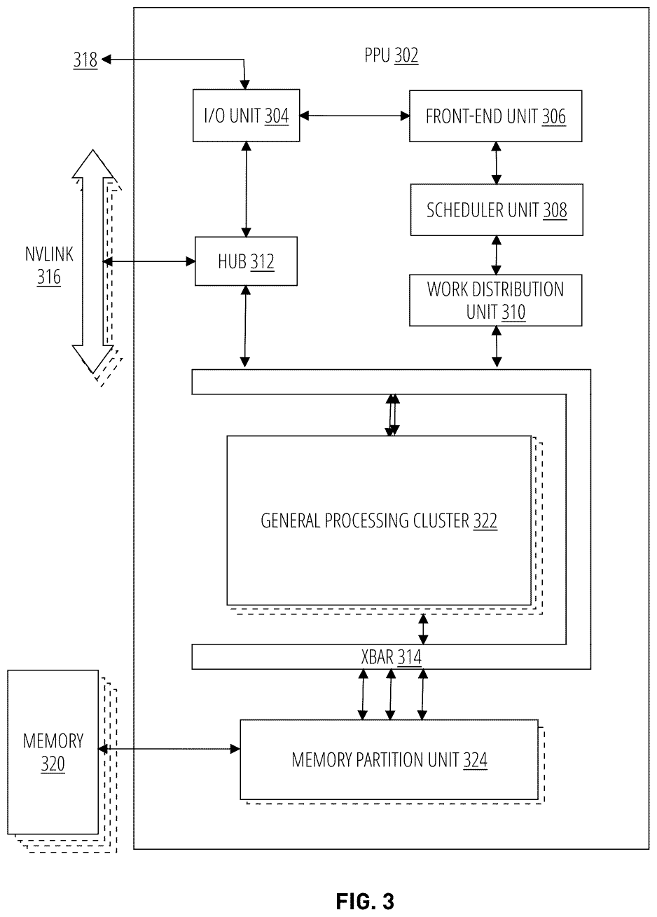

FIG. 3 depicts a parallel processing unit 302, in accordance with an embodiment. In an embodiment, the parallel processing unit 302 is a multi-threaded processor that is implemented on one or more integrated circuit devices. The parallel processing unit 302 is a latency hiding architecture designed to process many threads in parallel. A thread (e.g., a thread of execution) is an instantiation of a set of instructions configured to be executed by the parallel processing unit 302. In an embodiment, the parallel processing unit 302 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the parallel processing unit 302 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more parallel processing unit 302 modules may be configured to accelerate thousands of High Performance Computing (HPC), data center, and machine learning applications. The parallel processing unit 302 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 3, the parallel processing unit 302 includes an I/O unit 304, a front-end unit 306, a scheduler unit 308, a work distribution unit 310, a hub 312, a crossbar 314, one or more general processing cluster 322 modules, and one or more memory partition unit 324 modules. The parallel processing unit 302 may be connected to a host processor or other parallel processing unit 302 modules via one or more high-speed NVLink 316 interconnects. The parallel processing unit 302 may be connected to a host processor or other peripheral devices via an interconnect 318. The parallel processing unit 302 may also be connected to a local memory comprising a number of memory 320 devices. In an embodiment, the local memory may comprise a number of dynamic random access memory (DRAM) devices. The DRAM devices may be configured as a high-bandwidth memory (HBM) subsystem, with multiple DRAM dies stacked within each device. The memory 320 may comprise logic to configure the parallel processing unit 302 to carry out aspects of the techniques disclosed herein.

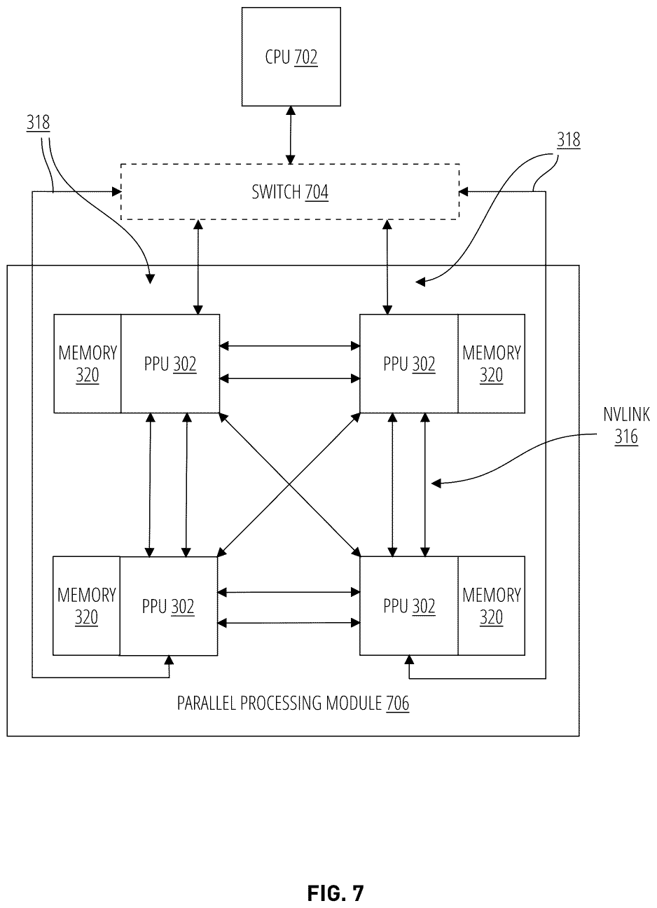

The NVLink 316 interconnect enables systems to scale and include one or more parallel processing unit 302 modules combined with one or more CPUs, supports cache coherence between the parallel processing unit 302 modules and CPUs, and CPU mastering. Data and/or commands may be transmitted by the NVLink 316 through the hub 312 to/from other units of the parallel processing unit 302 such as one or more copy engines, a video encoder, a video decoder, a power management unit, etc. (not explicitly shown). The NVLink 316 is described in more detail in conjunction with FIG. 7.

The I/O unit 304 is configured to transmit and receive communications (e.g., commands, data, etc.) from a host processor (not shown) over the interconnect 318. The I/O unit 304 may communicate with the host processor directly via the interconnect 318 or through one or more intermediate devices such as a memory bridge. In an embodiment, the I/O unit 304 may communicate with one or more other processors, such as one or more parallel processing unit 302 modules via the interconnect 318. In an embodiment, the I/O unit 304 implements a Peripheral Component Interconnect Express (PCIe) interface for communications over a PCIe bus and the interconnect 318 is a PCIe bus. In alternative embodiments, the I/O unit 304 may implement other types of well-known interfaces for communicating with external devices.

The I/O unit 304 decodes packets received via the interconnect 318. In an embodiment, the packets represent commands configured to cause the parallel processing unit 302 to perform various operations. The I/O unit 304 transmits the decoded commands to various other units of the parallel processing unit 302 as the commands may specify. For example, some commands may be transmitted to the front-end unit 306. Other commands may be transmitted to the hub 312 or other units of the parallel processing unit 302 such as one or more copy engines, a video encoder, a video decoder, a power management unit, etc. (not explicitly shown). In other words, the I/O unit 304 is configured to route communications between and among the various logical units of the parallel processing unit 302.

In an embodiment, a program executed by the host processor encodes a command stream in a buffer that provides workloads to the parallel processing unit 302 for processing. A workload may comprise several instructions and data to be processed by those instructions. The buffer is a region in a memory that is accessible (e.g., read/write) by both the host processor and the parallel processing unit 302. For example, the I/O unit 304 may be configured to access the buffer in a system memory connected to the interconnect 318 via memory requests transmitted over the interconnect 318. In an embodiment, the host processor writes the command stream to the buffer and then transmits a pointer to the start of the command stream to the parallel processing unit 302. The front-end unit 306 receives pointers to one or more command streams. The front-end unit 306 manages the one or more streams, reading commands from the streams and forwarding commands to the various units of the parallel processing unit 302.

The front-end unit 306 is coupled to a scheduler unit 308 that configures the various general processing cluster 322 modules to process tasks defined by the one or more streams. The scheduler unit 308 is configured to track state information related to the various tasks managed by the scheduler unit 308. The state may indicate which general processing cluster 322 a task is assigned to, whether the task is active or inactive, a priority level associated with the task, and so forth. The scheduler unit 308 manages the execution of a plurality of tasks on the one or more general processing cluster 322 modules.

The scheduler unit 308 is coupled to a work distribution unit 310 that is configured to dispatch tasks for execution on the general processing cluster 322 modules. The work distribution unit 310 may track a number of scheduled tasks received from the scheduler unit 308. In an embodiment, the work distribution unit 310 manages a pending task pool and an active task pool for each of the general processing cluster 322 modules. The pending task pool may comprise a number of slots (e.g., 32 slots) that contain tasks assigned to be processed by a particular general processing cluster 322. The active task pool may comprise a number of slots (e.g., 4 slots) for tasks that are actively being processed by the general processing cluster 322 modules. As a general processing cluster 322 finishes the execution of a task, that task is evicted from the active task pool for the general processing cluster 322 and one of the other tasks from the pending task pool is selected and scheduled for execution on the general processing cluster 322. If an active task has been idle on the general processing cluster 322, such as while waiting for a data dependency to be resolved, then the active task may be evicted from the general processing cluster 322 and returned to the pending task pool while another task in the pending task pool is selected and scheduled for execution on the general processing cluster 322.

The work distribution unit 310 communicates with the one or more general processing cluster 322 modules via crossbar 314. The crossbar 314 is an interconnect network that couples many of the units of the parallel processing unit 302 to other units of the parallel processing unit 302. For example, the crossbar 314 may be configured to couple the work distribution unit 310 to a particular general processing cluster 322. Although not shown explicitly, one or more other units of the parallel processing unit 302 may also be connected to the crossbar 314 via the hub 312.

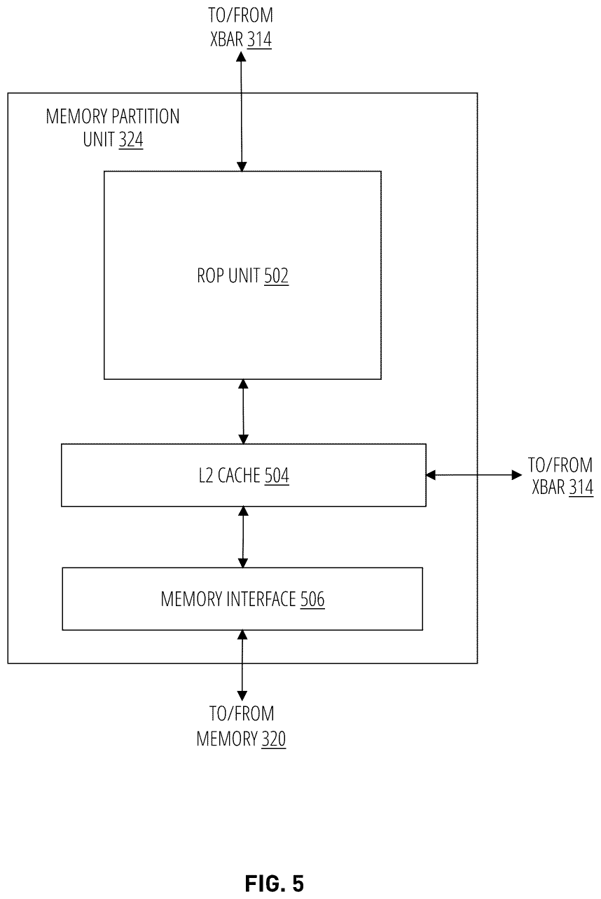

The tasks are managed by the scheduler unit 308 and dispatched to a general processing cluster 322 by the work distribution unit 310. The general processing cluster 322 is configured to process the task and generate results. The results may be consumed by other tasks within the general processing cluster 322, routed to a different general processing cluster 322 via the crossbar 314, or stored in the memory 320. The results can be written to the memory 320 via the memory partition unit 324 modules, which implement a memory interface for reading and writing data to/from the memory 320. The results can be transmitted to another parallel processing unit 302 or CPU via the NVLink 316. In an embodiment, the parallel processing unit 302 includes a number U of memory partition unit 324 modules that is equal to the number of separate and distinct memory 320 devices coupled to the parallel processing unit 302. A memory partition unit 324 will be described in more detail below in conjunction with FIG. 5.

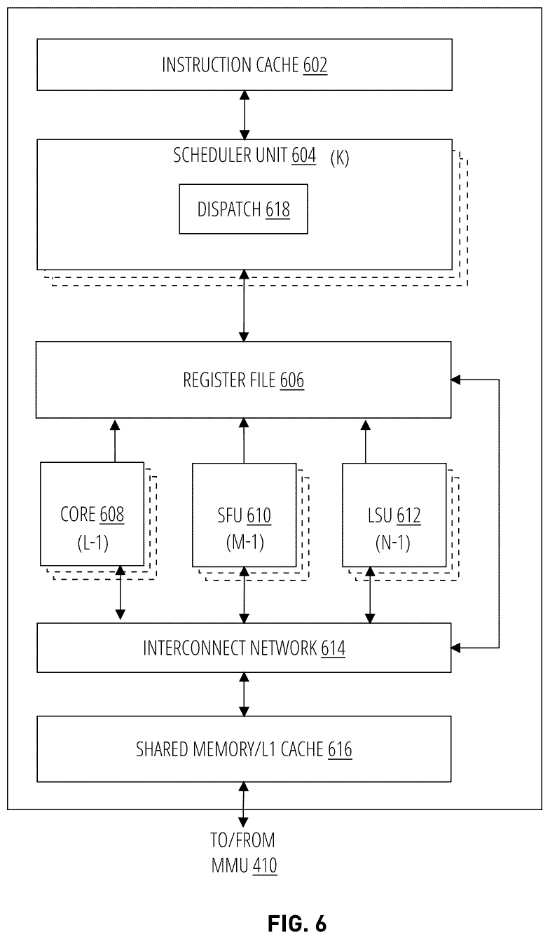

In an embodiment, a host processor executes a driver kernel that implements an application programming interface (API) that enables one or more applications executing on the host processor to schedule operations for execution on the parallel processing unit 302. In an embodiment, multiple compute applications are simultaneously executed by the parallel processing unit 302 and the parallel processing unit 302 provides isolation, quality of service (QoS), and independent address spaces for the multiple compute applications. An application may generate instructions (e.g., API calls) that cause the driver kernel to generate one or more tasks for execution by the parallel processing unit 302. The driver kernel outputs tasks to one or more streams being processed by the parallel processing unit 302. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 6.

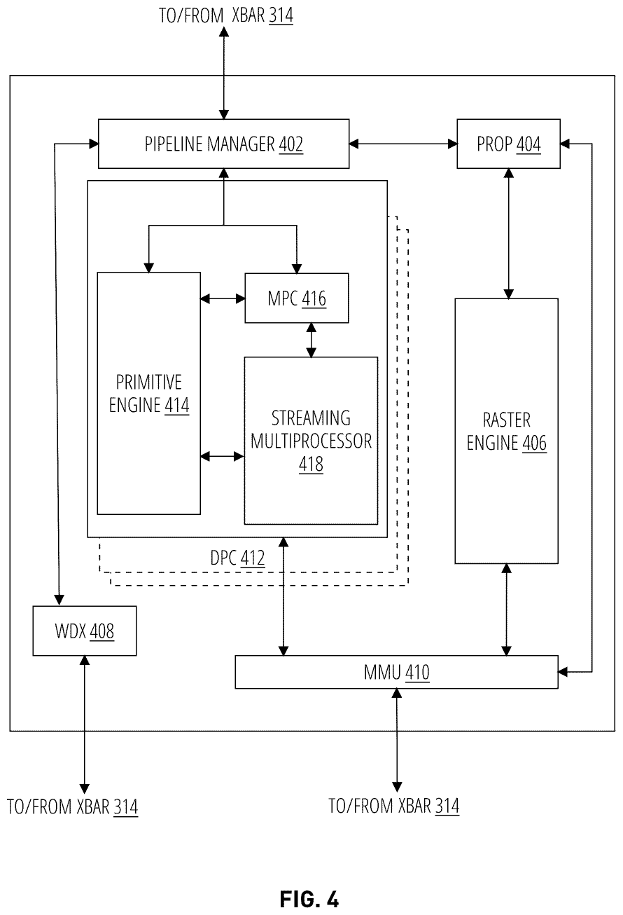

FIG. 4 depicts a general processing cluster 322 of the parallel processing unit 302 of FIG. 3, in accordance with an embodiment. As shown in FIG. 4, each general processing cluster 322 includes a number of hardware units for processing tasks. In an embodiment, each general processing cluster 322 includes a pipeline manager 402, a pre-raster operations unit 404, a raster engine 406, a work distribution crossbar 408, a memory management unit 410, and one or more data processing cluster 412. It will be appreciated that the general processing cluster 322 of FIG. 4 may include other hardware units in lieu of or in addition to the units shown in FIG. 4.

In an embodiment, the operation of the general processing cluster 322 is controlled by the pipeline manager 402. The pipeline manager 402 manages the configuration of the one or more data processing cluster 412 modules for processing tasks allocated to the general processing cluster 322. In an embodiment, the pipeline manager 402 may configure at least one of the one or more data processing cluster 412 modules to implement at least a portion of a graphics rendering pipeline. For example, a data processing cluster 412 may be configured to execute a vertex shader program on the programmable streaming multiprocessor 418. The pipeline manager 402 may also be configured to route packets received from the work distribution unit 310 to the appropriate logical units within the general processing cluster 322. For example, some packets may be routed to fixed function hardware units in the pre-raster operations unit 404 and/or raster engine 406 while other packets may be routed to the data processing cluster 412 modules for processing by the primitive engine 414 or the streaming multiprocessor 418. In an embodiment, the pipeline manager 402 may configure at least one of the one or more data processing cluster 412 modules to implement a neural network model and/or a computing pipeline.

The pre-raster operations unit 404 is configured to route data generated by the raster engine 406 and the data processing cluster 412 modules to a Raster Operations (ROP) unit, described in more detail in conjunction with FIG. 5. The pre-raster operations unit 404 may also be configured to perform optimizations for color blending, organize pixel data, perform address translations, and the like.

The raster engine 406 includes a number of fixed function hardware units configured to perform various raster operations. In an embodiment, the raster engine 406 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x, y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 406 comprises fragments to be processed, for example, by a fragment shader implemented within a data processing cluster 412.

Each data processing cluster 412 included in the general processing cluster 322 includes an M-pipe controller 416, a primitive engine 414, and one or more streaming multiprocessor 418 modules. The M-pipe controller 416 controls the operation of the data processing cluster 412, routing packets received from the pipeline manager 402 to the appropriate units in the data processing cluster 412. For example, packets associated with a vertex may be routed to the primitive engine 414, which is configured to fetch vertex attributes associated with the vertex from the memory 320. In contrast, packets associated with a shader program may be transmitted to the streaming multiprocessor 418.

The streaming multiprocessor 418 comprises a programmable streaming processor that is configured to process tasks represented by a number of threads. Each streaming multiprocessor 418 is multi-threaded and configured to execute a plurality of threads (e.g., 32 threads) from a particular group of threads concurrently. In an embodiment, the streaming multiprocessor 418 implements a Single-Instruction, Multiple-Data (SIMD) architecture where each thread in a group of threads (e.g., a warp) is configured to process a different set of data based on the same set of instructions. All threads in the group of threads execute the same instructions. In another embodiment, the streaming multiprocessor 418 implements a Single-Instruction, Multiple Thread (SIMT) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The streaming multiprocessor 418 will be described in more detail below in conjunction with FIG. 6.

The memory management unit 410 provides an interface between the general processing cluster 322 and the memory partition unit 324. The memory management unit 410 may provide translation of virtual addresses into physical addresses, memory protection, and arbitration of memory requests. In an embodiment, the memory management unit 410 provides one or more translation lookaside buffers (TLBs) for performing translation of virtual addresses into physical addresses in the memory 320.

FIG. 5 depicts a memory partition unit 324 of the parallel processing unit 302 of FIG. 3, in accordance with an embodiment. As shown in FIG. 5, the memory partition unit 324 includes a raster operations unit 502, a level two cache 504, and a memory interface 506. The memory interface 506 is coupled to the memory 320. Memory interface 506 may implement 32, 64, 128, 1024-bit data buses, or the like, for high-speed data transfer. In an embodiment, the parallel processing unit 302 incorporates U memory interface 506 modules, one memory interface 506 per pair of memory partition unit 324 modules, where each pair of memory partition unit 324 modules is connected to a corresponding memory 320 device. For example, parallel processing unit 302 may be connected to up to Y memory 320 devices, such as high bandwidth memory stacks or graphics double-data-rate, version 5, synchronous dynamic random access memory, or other types of persistent storage.

In an embodiment, the memory interface 506 implements an HBM2 memory interface and Y equals half U. In an embodiment, the HBM2 memory stacks are located on the same physical package as the parallel processing unit 302, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 320 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where parallel processing unit 302 modules process very large datasets and/or run applications for extended periods.

In an embodiment, the parallel processing unit 302 implements a multi-level memory hierarchy. In an embodiment, the memory partition unit 324 supports a unified memory to provide a single unified virtual address space for CPU and parallel processing unit 302 memory, enabling data sharing between virtual memory systems. In an embodiment the frequency of accesses by a parallel processing unit 302 to memory located on other processors is traced to ensure that memory pages are moved to the physical memory of the parallel processing unit 302 that is accessing the pages more frequently. In an embodiment, the NVLink 316 supports address translation services allowing the parallel processing unit 302 to directly access a CPU's page tables and providing full access to CPU memory by the parallel processing unit 302.

In an embodiment, copy engines transfer data between multiple parallel processing unit 302 modules or between parallel processing unit 302 modules and CPUs. The copy engines can generate page faults for addresses that are not mapped into the page tables. The memory partition unit 324 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 320 or other system memory may be fetched by the memory partition unit 324 and stored in the level two cache 504, which is located on-chip and is shared between the various general processing cluster 322 modules. As shown, each memory partition unit 324 includes a portion of the level two cache 504 associated with a corresponding memory 320 device. Lower level caches may then be implemented in various units within the general processing cluster 322 modules. For example, each of the streaming multiprocessor 418 modules may implement an L1 cache. The L1 cache is private memory that is dedicated to a particular streaming multiprocessor 418. Data from the level two cache 504 may be fetched and stored in each of the L1 caches for processing in the functional units of the streaming multiprocessor 418 modules. The level two cache 504 is coupled to the memory interface 506 and the crossbar 314.

The raster operations unit 502 performs graphics raster operations related to pixel color, such as color compression, pixel blending, and the like. The raster operations unit 502 also implements depth testing in conjunction with the raster engine 406, receiving a depth for a sample location associated with a pixel fragment from the culling engine of the raster engine 406. The depth is tested against a corresponding depth in a depth buffer for a sample location associated with the fragment. If the fragment passes the depth test for the sample location, then the raster operations unit 502 updates the depth buffer and transmits a result of the depth test to the raster engine 406. It will be appreciated that the number of partition memory partition unit 324 modules may be different than the number of general processing cluster 322 modules and, therefore, each raster operations unit 502 may be coupled to each of the general processing cluster 322 modules. The raster operations unit 502 tracks packets received from the different general processing cluster 322 modules and determines which general processing cluster 1 that a result generated by the raster operations unit 502 is routed to through the crossbar 314. Although the raster operations unit 502 is included within the memory partition unit 324 in FIG. 5, in other embodiment, the raster operations unit 502 may be outside of the memory partition unit 324. For example, the raster operations unit 502 may reside in the general processing cluster 322 or another unit.

FIG. 6 illustrates the streaming multiprocessor 418 of FIG. 4, in accordance with an embodiment. As shown in FIG. 6, the streaming multiprocessor 418 includes an instruction cache 602, one or more scheduler unit 604 modules (e.g., such as scheduler unit 308), a register file 606, one or more processing core 608 modules, one or more special function unit 610 modules, one or more load/store unit 612 modules, an interconnect network 614, and a shared memory/L1 cache 616.

As described above, the work distribution unit 310 dispatches tasks for execution on the general processing cluster 322 modules of the parallel processing unit 302. The tasks are allocated to a particular data processing cluster 412 within a general processing cluster 322 and, if the task is associated with a shader program, the task may be allocated to a streaming multiprocessor 418. The scheduler unit 308 receives the tasks from the work distribution unit 310 and manages instruction scheduling for one or more thread blocks assigned to the streaming multiprocessor 418. The scheduler unit 604 schedules thread blocks for execution as warps of parallel threads, where each thread block is allocated at least one warp. In an embodiment, each warp executes 32 threads. The scheduler unit 604 may manage a plurality of different thread blocks, allocating the warps to the different thread blocks and then dispatching instructions from the plurality of different cooperative groups to the various functional units (e.g., core 608 modules, special function unit 610 modules, and load/store unit 612 modules) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch 618 unit is configured within the scheduler unit 604 to transmit instructions to one or more of the functional units. In one embodiment, the scheduler unit 604 includes two dispatch 618 units that enable two different instructions from the same warp to be dispatched during each clock cycle. In alternative embodiments, each scheduler unit 604 may include a single dispatch 618 unit or additional dispatch 618 units.

Each streaming multiprocessor 418 includes a register file 606 that provides a set of registers for the functional units of the streaming multiprocessor 418. In an embodiment, the register file 606 is divided between each of the functional units such that each functional unit is allocated a dedicated portion of the register file 606. In another embodiment, the register file 606 is divided between the different warps being executed by the streaming multiprocessor 418. The register file 606 provides temporary storage for operands connected to the data paths of the functional units.

Each streaming multiprocessor 418 comprises L processing core 608 modules. In an embodiment, the streaming multiprocessor 418 includes a large number (e.g., 128, etc.) of distinct processing core 608 modules. Each core 608 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the core 608 modules include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the core 608 modules. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A′B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each streaming multiprocessor 418 also comprises M special function unit 610 modules that perform special functions (e.g., attribute evaluation, reciprocal square root, and the like). In an embodiment, the special function unit 610 modules may include a tree traversal unit configured to traverse a hierarchical tree data structure. In an embodiment, the special function unit 610 modules may include texture unit configured to perform texture map filtering operations. In an embodiment, the texture units are configured to load texture maps (e.g., a 2D array of texels) from the memory 320 and sample the texture maps to produce sampled texture values for use in shader programs executed by the streaming multiprocessor 418. In an embodiment, the texture maps are stored in the shared memory/L1 cache 616. The texture units implement texture operations such as filtering operations using mip-maps (e.g., texture maps of varying levels of detail). In an embodiment, each streaming multiprocessor 418 includes two texture units.

Each streaming multiprocessor 418 also comprises N load/store unit 612 modules that implement load and store operations between the shared memory/L1 cache 616 and the register file 606. Each streaming multiprocessor 418 includes an interconnect network 614 that connects each of the functional units to the register file 606 and the load/store unit 612 to the register file 606 and shared memory/L1 cache 616. In an embodiment, the interconnect network 614 is a crossbar that can be configured to connect any of the functional units to any of the registers in the register file 606 and connect the load/store unit 612 modules to the register file 606 and memory locations in shared memory/L1 cache 616.

The shared memory/L1 cache 616 is an array of on-chip memory that allows for data storage and communication between the streaming multiprocessor 418 and the primitive engine 414 and between threads in the streaming multiprocessor 418. In an embodiment, the shared memory/L1 cache 616 comprises 128 KB of storage capacity and is in the path from the streaming multiprocessor 418 to the memory partition unit 324. The shared memory/L1 cache 616 can be used to cache reads and writes. One or more of the shared memory/L1 cache 616, level two cache 504, and memory 320 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 616 enables the shared memory/L1 cache 616 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 3, are bypassed, creating a much simpler programming model. In the general purpose parallel computation configuration, the work distribution unit 310 assigns and distributes blocks of threads directly to the data processing cluster 412 modules. The threads in a block execute the same program, using a unique thread ID in the calculation to ensure each thread generates unique results, using the streaming multiprocessor 418 to execute the program and perform calculations, shared memory/L1 cache 616 to communicate between threads, and the load/store unit 612 to read and write global memory through the shared memory/L1 cache 616 and the memory partition unit 324. When configured for general purpose parallel computation, the streaming multiprocessor 418 can also write commands that the scheduler unit 308 can use to launch new work on the data processing cluster 412 modules.

The parallel processing unit 302 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the parallel processing unit 302 is embodied on a single semiconductor substrate. In another embodiment, the parallel processing unit 302 is included in a system-on-a-chip (SoC) along with one or more other devices such as additional parallel processing unit 302 modules, the memory 320, a reduced instruction set computer (RISC) CPU, a memory management unit (MMU), a digital-to-analog converter (DAC), and the like.

In an embodiment, the parallel processing unit 302 may be included on a graphics card that includes one or more memory devices. The graphics card may be configured to interface with a PCIe slot on a motherboard of a desktop computer. In yet another embodiment, the parallel processing unit 302 may be an integrated graphics processing unit (iGPU) or parallel processor included in the chipset of the motherboard.

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 7 is a conceptual diagram of a processing system implemented using the parallel processing unit 302 of FIG. 3, in accordance with an embodiment. The processing system includes a central processing unit 702, an switch 704, and multiple parallel processing unit 302 modules each and respective memory 320 modules. The switch 704 is depicted with dashed lines, indicating that it is optional in some embodiments.

The NVLink 316 provides high-speed communication links between each of the parallel processing unit 302 modules. Although a particular number of NVLink 316 and interconnect 318 connections are illustrated in FIG. 7, the number of connections to each parallel processing unit 302 and the central processing unit 702 may vary. The switch 704 interfaces between the interconnect 318 and the central processing unit 702. The parallel processing unit 302 modules, memory 320 modules, and NVLink 316 connections may be situated on a single semiconductor platform to form a parallel processing module 706. In an embodiment, the switch 704 supports two or more protocols to interface between various different connections and/or links.

In another embodiment (not shown), the NVLink 316 provides one or more high-speed communication links between each of the parallel processing unit modules (parallel processing unit 302, parallel processing unit 302, parallel processing unit 302, and parallel processing unit 302) and the central processing unit 702 and the switch 704 (when present) interfaces between the interconnect 318 and each of the parallel processing unit modules. The parallel processing unit modules, memory 320 modules, and interconnect 318 may be situated on a single semiconductor platform to form a parallel processing module 706. In yet another embodiment (not shown), the interconnect 318 provides one or more communication links between each of the parallel processing unit modules and the central processing unit 702 and the switch 704 interfaces between each of the parallel processing unit modules using the NVLink 316 to provide one or more high-speed communication links between the parallel processing unit modules. In another embodiment (not shown), the NVLink 316 provides one or more high-speed communication links between the parallel processing unit modules and the central processing unit 702 through the switch 704. In yet another embodiment (not shown), the interconnect 318 provides one or more communication links between each of the parallel processing unit modules directly. One or more of the NVLink 316 high-speed communication links may be implemented as a physical NVLink interconnect or either an on-chip or on-die interconnect using the same protocol as the NVLink 316.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 706 may be implemented as a circuit board substrate and each of the parallel processing unit modules and/or memory 320 modules may be packaged devices. In an embodiment, the central processing unit 702, switch 704, and the parallel processing module 706 are situated on a single semiconductor platform.

In an embodiment, each parallel processing unit module includes six NVLink 316 interfaces (as shown in FIG. 7, five NVLink 316 interfaces are included for each parallel processing unit module). The NVLink 316 may be operated exclusively for PPU-to-PPU communication as shown in FIG. 7, or some combination of PPU-to-PPU and PPU-to-CPU, when the central processing unit 702 also includes one or more NVLink 316 interfaces.

In an embodiment, the NVLink 316 allows direct load/store/atomic access from the central processing unit 702 to each parallel processing unit module's memory 320. In an embodiment, the NVLink 316 supports coherency operations, allowing data read from the memory 320 modules to be stored in the cache hierarchy of the central processing unit 702, reducing cache access latency for the central processing unit 702. In an embodiment, the NVLink 316 includes support for Address Translation Services (ATS), enabling the parallel processing unit module to directly access page tables within the central processing unit 702. One or more of the NVLink 316 may also be configured to operate in a low-power mode.

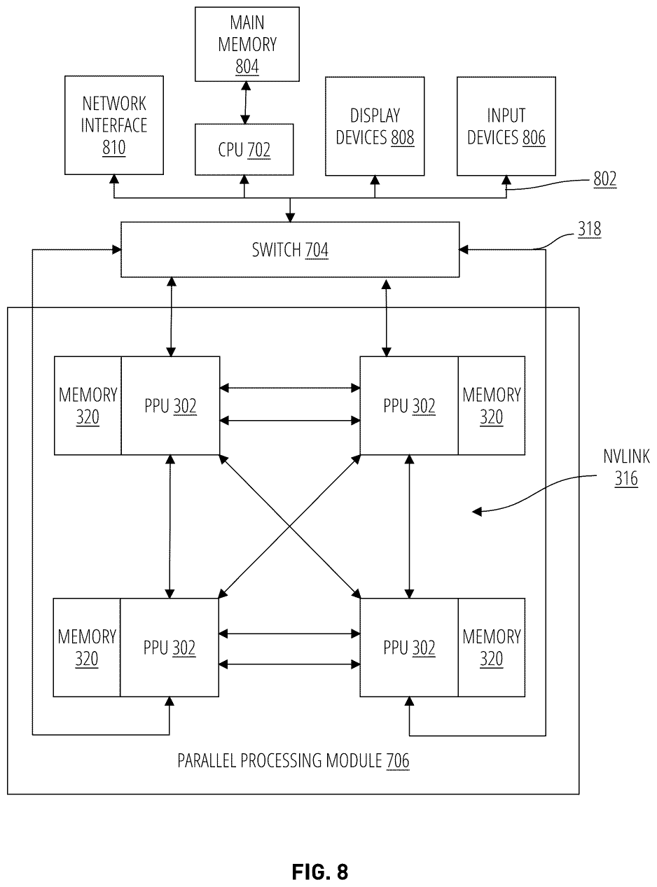

FIG. 8 depicts an exemplary processing system in which the various architecture and/or functionality of the various previous embodiments may be implemented. As shown, an exemplary processing system is provided including at least one central processing unit 702 that is connected to a communications bus 802. The communication communications bus 802 may be implemented using any suitable protocol, such as PCI (Peripheral Component Interconnect), PCI-Express, AGP (Accelerated Graphics Port), HyperTransport, or any other bus or point-to-point communication protocol(s). The exemplary processing system also includes a main memory 804. Control logic (software) and data are stored in the main memory 804 which may take the form of random access memory (RAM). For simplicity of illustration, the main memory 804 may be understood to comprise other forms of bulk memory, including non-volatile memory technologies.

The exemplary processing system also includes input devices 806, the parallel processing module 706, and display devices 808, e.g. a conventional CRT (cathode ray tube), LCD (liquid crystal display), LED (light emitting diode), plasma display or the like. User input may be received from the input devices 806, e.g., keyboard, mouse, touchpad, microphone, and the like. Each of the foregoing modules and/or devices may even be situated on a single semiconductor platform to form the exemplary processing system. Alternately, the various modules may also be situated separately or in various combinations of semiconductor platforms per the desires of the user.

Further, the exemplary processing system may be coupled to a network (e.g., a telecommunications network, local area network (LAN), wireless network, wide area network (WAN) such as the Internet, peer-to-peer network, cable network, or the like) through a network interface 810 for communication purposes.

The exemplary processing system may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 804 and/or the secondary storage. Such computer programs, when executed, enable the exemplary processing system to perform various functions. The main memory 804, the storage, and/or any other storage are possible examples of computer-readable media (volatile and/or non-volatile, depending on the implementation).

The architecture and/or functionality of the various previous figures may be implemented in the context of a general computer system, a circuit board system, a game console system dedicated for entertainment purposes, an application-specific system, and/or any other desired system. For example, the exemplary processing system may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

An exemplary implementation may utilize a video encoder pre-trained on with many video clips. The perception model may be fine-tuned by training on a limited number of synthetic datasets comprising a varying range of annotations, utilizing priors from the pre-trained video encoder to enable zero-shot generalization. Zero-shot generalization means that the system may perform well on inference tasks with inputs that do not closely align with the content of the training set for the model. Kubric for example is a synthetic dataset with multi-object interactions with many random objects that may be used to generate annotations for depth, flow, motion-based segmentation, and 3D tracking.

Videos with long 3D trajectories may be obtained from sources such as PointOdyssey and DynamicReplica, each comprising mostly indoor synthetic datasets with dynamic characters. From these datasets, depth annotations may also be obtained. DynamicReplica may also act as a source of flow annotations. To increase scene-level data distribution, TartanAir may be utilized to generate annotations for flow and depth.

In one embodiment, the video encoder may process video clips of size 16×224×224, using a patch-size of 2×14×14, resulting in P=2048 video tokens and an embedding dimension of C=1408. The video encoder may comprise 40 encoder blocks. The output from blocks [14, 21, 28, 36] may be used for DPT heads for dense tasks, while the sparse-head uses features from the final (40th) encoder block.

The perception model may be trained in two-stages. In the first stage end-to-end training may be applied for all tasks on a single window of t=16 frames. In the second stage the model may be fine-tuned for the tracking tasks using unrolled-window training. In both stages, for tracking tasks, a batch of many tracks may be constructed per video. For the second stage, training may be carried out on videos of length S=40, windows of size 16 frames, and a stride of 8, resulting in 5 overlapping windows. Both stages may utilize a batch-size of 8.

The motion-based segmentation may be obviated during the training, and instead the lightweight DPT-head may be configured using the pretrained video encoder.

For loss calculation during depth training, an SILog loss may be applied to urge the model to produce scale-invariant estimations. For flow training, L1-loss may be applied on estimated uv offsets. For tracking training, L1-loss may be applied on the 2D track positions, a scale-invariant loss may be applied for depth (similar to dense depth), and a binary-cross entropy loss may be applied for visibility.

### LISTING OF DRAWING ELEMENTS

102 video encoder
104 video
106 dense attention head
108 sparse attention head
110 output video tokens
202 two-way attention layer
204 feature map
302 parallel processing unit
304 I/O unit
306 front-end unit
308 scheduler unit
310 work distribution unit
312 hub
314 crossbar
316 NVLink
318 interconnect
320 memory
322 general processing cluster
324 memory partition unit
402 pipeline manager
404 pre-raster operations unit
406 raster engine
408 work distribution crossbar
410 memory management unit
412 data processing cluster
414 primitive engine
416 M-pipe controller
418 streaming multiprocessor
502 raster operations unit
504 level two cache
506 memory interface
602 instruction cache
604 scheduler unit
606 register file
608 core
610 special function unit
612 load/store unit
614 interconnect network
616 shared memory/L1 cache
618 dispatch
702 central processing unit
704 switch
706 parallel processing module
802 communications bus
804 main memory
806 input devices
808 display devices
810 network interface

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media configured with machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory, and firmware are examples of logic. Logic specifically excludes pure signals or software per se (however does not exclude non-transitory machine memories comprising software and thereby forming statutory configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation-[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112 (f) for that claim element. Accordingly, claims in this application that do not otherwise include the “means for” [performing a function] construct should not be interpreted under 35 U.S.C § 112 (f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the disclosure as claimed. The scope of inventive subject matter is not limited to the depicted embodiments but is rather set forth in the following Claims.

What is claimed is:

1. A feedforward reasoning model comprising:
a video encoder configured to generate feature tokens from an input video;
at least one dense attention head;
at least one sparse attention head comprising two-way attention logic configured to transform settings from the feature tokens into a tracking token, a depth token, and a visibility token in accordance with an input prompt; and
logic configured to transform the tracking token, depth token, and visibility token into track predictions for an object specified by the input prompt.

2. The feedforward reasoning model of claim 1, wherein the track predictions are two-dimensional (2D).

3. The feedforward reasoning model of claim 1, wherein the track predictions are three-dimensional (3D).

4. The feedforward reasoning model of claim 1, wherein the at least one dense attention head is configured to transform the feature tokens into a depth map, optical flow map, or motion based segmentation map.

5. The feedforward reasoning model of claim 1, wherein the at least one sparse attention head is configured to process the feature tokens in a window size of T timesteps where T is less than a number of timesteps in the input video.

6. The feedforward reasoning model of claim 5, wherein the process windows are configured to overlap one another.

7. The feedforward reasoning model of claim 6, further comprising a token configured to carry tracking information between process windows for adjacent timesteps.

8. The feedforward reasoning model of claim 1, wherein the logic to transform the tracking token, depth token, and visibility token into track predictions for an object specified by the input prompt comprises:
logic to form an inner product of (a) feature maps formed from the feature tokens, and (b) the tracking token, depth token, and visibility token.

9. The feedforward reasoning model of claim 1, wherein the at least one dense attention head comprises a Dual Path Transformer (DPT).

10. The feedforward reasoning model of claim 9, wherein the DPT is configured to perform 3D convolutions.

11. The feedforward reasoning model of claim 10, comprising multiple DPT heads each configured with a different output layer.

12. The feedforward reasoning model of claim 1, wherein the two-way attention logic comprises a pair of two-way attention network layers.

13. The feedforward reasoning model of claim 1, wherein the two-way attention logic comprises a mask-decoder of a segmenting model configured to perform 3D convolutions.

14. A non-volatile machine-readable medium comprising instructions that, when applied to one or more data processor, configure a computer system comprising the one or more data processor to:
receive feature tokens for an input video from a video encoder;
transform, in accordance with an input prompt, settings from the feature tokens into a tracking token, a depth token, and a visibility token through at least one sparse attention head comprising two-way attention logic; and
transform the tracking token, depth token, and visibility token into track predictions for an object depicted in the input video and specified by the input prompt.

15. The non-volatile machine-readable medium of claim 14, wherein the track predictions are two-dimensional (2D).

16. The non-volatile machine-readable medium of claim 14, wherein the track predictions are three-dimensional (3D).

17. The non-volatile machine-readable medium of claim 14, further comprising instructions that, when applied to the one or more data processor, further configure the computer system to transform the feature tokens through at least one dense attention head into one or more depth map, optical flow map, and motion based segmentation map.

18. The non-volatile machine-readable medium of claim 17, wherein the at least one dense attention head comprises a Dual Path Transformer (DPT).

19. The non-volatile machine-readable medium of claim 14, further comprising instructions that, when applied to the one or more data processor, configure the at least one sparse attention head to process the feature tokens in a window size of T timesteps where T is less than a number of timesteps in the input video.

20. The non-volatile machine-readable medium of claim 19, wherein the process windows are configured to overlap one another.

21. The non-volatile machine-readable medium of claim 20, further comprising instructions that, when applied to the one or more data processor, further configure the computer system to:
utilize a token to carry tracking information between process windows for adjacent timesteps.

22. The non-volatile machine-readable medium of claim 14, wherein transforming the tracking token, depth token, and visibility token into track predictions for the object comprises:
forming an inner product of (a) feature maps formed from the feature tokens, and (b) the tracking token, depth token, and visibility token.

23. A process comprising:
transforming, in accordance with an input prompt, settings from the feature tokens received from a video encoder into a tracking token, a depth token, and a visibility token through at least one sparse attention head comprising two-way attention logic; and
transforming the tracking token, depth token, and visibility token into track predictions for an object depicted in the input video and specified by the input prompt.
